(19) United States
(12) Patent Application Publication
(10) Pub. No.: US 2006/0042743 A1
(43) Pub. Date: Mar. 2, 2006

(54) Applicator for magnetic marker and method

(75) Inventors: Stefan Voinea, Brossard (CA); Joel Fernando Rous, Roxboro (CA)

Correspondence Address: OGILVY RENAULT LLP, 1981 MCGILL COLLEGE AVENUE, SUITE 1600, MONTREAL, QC, H3A2Y3, CA

(73) Assignee: MXT INC.

(21) Appl. No.: 11/213,894

(22) Filed: Aug. 30, 2005

Related U.S. Application Data
(63) Continuation-in-part of application No. PCT/CA04/01609, filed on Sep. 1, 2004.

(51) Int. Cl. B29C 70/52; G06K 19/06; G08B 13/14; H01R 43/00

(52) U.S. Cl. 156/166; 340/572.8; 235/492; 29/825

(57) ABSTRACT

A method and device for delivering a remotely detectable tag for tagging an article; the method comprises the steps of: (a) advancing a continuous pressure sensitive tape from a first source such that said tape travels along a first path, the tape having an adhesive side and an opposed non-adhesive side, (b) advancing a continuous sensor element substrate of a remotely detectable material from a second source and into adhering engagement with the adhesive side of said tape so as to form a composite tagging tape downstream of the first and second sources, (c) advancing the tagging tape along the first path so as to provide a free protruding forward end portion of tagging tape, and (d) severing the forward end portion as a tag of the pressure sensitive tape bearing a sensor element of the substrate on the adhesive side of the tape. The method and device particulars provide for stiffening the tagging tape to facilitate advancing the tape with the free forward end portion; a replacement cartridge and an applicator which are components of the device from separate aspects of the invention.

### CROSS-REFERENCE TO RELATED APPLICATIONS

This application is a Continuation-in-part of International Application PCT/CA2004/001609, filed Sep. 1, 2004 designating the USA, which application is still pending.

### BACKGROUND OF INVENTION

i) Field of Invention

This invention relates to the application of a surveillance marker, for example a magnetic surveillance marker, to an article. More especially, the invention relates to a method of delivering a remotely detectable tag for tagging an article, and to a method of tagging an article, as well as to a device for forming a remotely detectable tag for an article, a replaceable pool cartridge of such a device and an applicator of such a device.

ii) Brief Description of Prior Art

It is a common practice for retail stores to protect articles for sale against theft by tagging them with magnetic surveillance markers, such that when the marker is introduced into an interrogation zone it causes a detectable magnetic field disturbance which is used to activate an alarm. Such markers commonly include a deactivating element whereby the marker may be rendered undetectable.

Most commonly the markers are in the form of adhesive labels or tags, which are purchased by the store and then applied to the desired articles in the store or in a warehouse, either manually or by means of a hand-held applicator. Because the labels contain several elements, including the sensor material, itself typically made up of an active element and a deactivating element, and either plastic or paper laminates, they are typically manufactured by specialist label-makers or converters and then sold to a distributor in the form of rolls, and the distributor in turn sells them to the retailer. This specialist manufacturing, followed by the distribution chain, adds considerably to the cost of tagging to the retailer, with the consequence that only relatively high-value articles in retail stores are typically protected against theft by this means.

To reduce the cost of tagging to the retailers various attempts have been made to mark the articles at source, that is to say at the time of manufacture or at the time of packaging. However most source marking consists of attaching pre-made tags or markers, thereby leaving the issue of the high tag cost unaddressed. In addition the rate at which pre-made labels or markers may be applied is limited, in turn limiting the rate of the manufacturing or packaging process. A modified approach to source tagging, described in U.S. Pat. No. 6,627,031, pre-combines the tagging material with a custom designed pressure sensitive adhesive tape so as to make the composite tagging tape continuous. The tagging tape is then placed into a specially designed high-speed applicator. In this applicator the article to be tagged moves at high speed past the applicator head, which feeds out the tagging tape at the same speed and synchronously cuts it into predetermined lengths and attaches it to the article. Although this method achieves high tagging rates, the cost of the special composite tagging tape remains high, and at any one time the articles being tagged must all be identical. Furthermore source marking at the point of manufacture or packaging suffers from the problem that at the current time several different incompatible electronic article surveillance (EAS) systems are being used in the marketplace, each with their own tags, so that source tagging requires separate stock-keeping units according to the type of tag applied, adding further to the cost. Also each type of applicator can only apply one type of tag. For example the applicator of U.S. Pat. No. 6,627,031 is only suitable for electromagnetic (em) tagging systems, and cannot be used for radio frequency (rf) or acoustomagnetic (am) tagging systems. For these and other reasons source marking using the approaches described above has yet to find widespread use, so that in practice the cost of tagging remains high.

EP 1 257 985 describes a deactivatable magnetic marker or sensor element sold by MXT Inc. of Montreal, Canada under the trademark SSDW. This marker or sensor element consists of a deactivating core made from a low-cost continuous stainless-steel wire which has been treated to form a continuous chain of semi-hard magnets linked by non-magnetic material. On to this core a soft magnetic outer layer is deposited that serves as the active element. When the core is magnetized the element is inactive; when the core is demagnetized the element is active. This sensor element can be incorporated directly into or onto an article to be tagged or can be affixed to a tape or label which is secured to the article to be tagged.

### DISCLOSURE OF THE INVENTION

It is an object of the invention to allow articles to be tagged manually at very low-cost.

It is another object of the invention to avoid the need to pre-convert the sensor element on to a suitable carrier before insertion in an applicator, or away from the site of application.

A still further object of the invention is to combine a continuous sensor element substrate with an adhesive tape and deliver a tag ready for application to an article without the need for a release liner

In accordance with one aspect of the invention, there is provided a method of delivering a remotely detectable tag for tagging an article comprising the steps of:
(a) advancing a continuous pressure sensitive tape from a first source such that said tape travels along a first path, said tape having an adhesive side and an opposed non-adhesive side,
(b) advancing a continuous sensor element substrate of a remotely detectable material from a second source adjacent said first source, and into adhering engagement with said adhesive side of said tape so as to form a composite tagging tape downstream of said first and second sources,
(c) advancing said tagging tape along said first path so as to provide a free protruding forward end portion of tagging tape, and
(d) severing said forward end portion as a tag of said pressure sensitive tape bearing a sensor element of said substrate on the adhesive side of the tape.

In a further aspect of the invention, there is provided a method of tagging an article with a remotely detectable tag comprising: delivering a tag in accordance with the method of the invention described herein, to an article, and adhering the tag to the article by means of the adhesive side of the tag.

In accordance with another aspect of the invention, there is provided a device for forming a remotely detectable tag for an article comprising:
(i) a first source of a continuous pressure sensitive tape having an adhesive side and an opposed non-adhesive side,
(ii) a second source of a continuous sensor element substrate of a remotely detectable material,
(iii) means for drawing said tape and said sensor element substrate and advancing them along first and second paths from said first and second sources, respectively, and into an engagement in which the advancing sensor element substrate is adheringly engaged by the adhesive side of the advancing tape to form an advancing tagging tape,
(iv) means for stiffening and guiding the advancing tagging tape so as to provide a free protruding forward end portion of tagging tape, and
(v) severing means to sever the forward end portion as a tag of said pressure sensitive tape bearing a sensor element of said substrate on the adhesive side of the tape.

In still another aspect of the invention, there is provided a replaceable spool cartridge for an applicator for forming a remotely detectable tag for an article comprising:
a housing having a spool chamber and an exit port,
a first spool of a continuous pressure sensitive tape and a second spool of a continuous sensor element substrate rotatably mounted in said housing,
said pressure sensitive tape having an adhesive side and a non-adhesive side, a tape guide for guiding tape from said first spool to said exit port, such that said tape guide engages said non-adhesive side, and
a substrate guide for guiding substrate from said second spool to said exit port,
said exit port having a narrow gap defined between closed spaced apart, opposed laminating walls such that said walls press said substrate and tape into adhering contact at said adhesive side of said tape, as said tape and substrate are drawn through said narrow gap.

In still another aspect of the invention, there is provided an applicator for forming a remotely detectable tag for an article comprising:

(I) drive means for driving a pressure sensitive tape and a sensor element substrate from first and second sources to form a composite tagging tape in which sensor element substrate is adhered to an adhesive side of the pressure sensitive tape, and for advancing the tagging tape,
(II) guide means for stiffening and guiding the advancing tagging tape so as to provide a free protruding forward end portion of tagging tape, and
(III) severing means to sever the forward end portion as a tag.

### DETAILED DESCRIPTION OF INVENTION

This invention achieves low tagging cost by employing a sensor element that is continuous and that contains both the active and deactivating component in integrated format and using this element in an applicator that combines the element with a suitable adhesive tape, cuts from the combined sensor and tape a marker of an appropriate length which is then applied to the article to be protected. By this means there is no need to pre-convert the material and the applicator may be directly loaded with the sensor material and a low-cost commercially available tape on two separate spools. In addition the applicator does not require the adhesive tape to have a release liner. The addition of a release liner, typically siliconized paper, adds significantly to the cost of the tape and also requires the operator of the applicator to dispose of the liner.

In an embodiment of the invention a pressure sensitive adhesive tape with no release liner is mounted on a spool next to and on the same axis as another spool containing a continuous sensor element substrate, such as SSDW (trademark of MXT Inc. and described in EP 1 257 985). The tape and the sensor element substrate pass between two rollers of an applicator, which pull both the sensor element substrate and the tape off their respective spools and also combine the two into an appropriate tagging tape by pressing the sensor element substrate onto the adhesive side of the tape. The tagging tape is then pushed by the two rollers through a guide onto an anvil where it is cut by a blade impacting the surface of the anvil. At the moment of cutting the tagging tape protrudes from the front of the applicator, and passes over a roller, which may be used to press the cut tag onto an article to be tagged. After cutting, the applicator is withdrawn, leaving the article tagged.

The applicator has a guide and a cutter. The guide leads the tagging tape onto the anvil but also stiffens the tagging tape so that it may be pushed forward from behind, rather than pulled forward from in front. By this means the front of the tagging tape is left free for application to the article. The guide suitably has an at least partially arcuate cross-section providing a concave elongate channel for the advancing tagging tape, for example a circular cross-section, or, preferably an oval or elliptical cross-section with the long axis of the oval or ellipse parallel to the plane of the tagging tape prior to entry into the guide. The curved form of the elongate channel bends the tape so that the non-adhesive side of the tape engages the concave wall of the channel and thereby stiffens the tape. The concave, preferably oval or elliptical wall automatically centers the tagging tape and allows it to be accurately pushed forward over the anvil. The guide continues past the anvil to allow the tagging tape to be pushed further forward so as to exit the applicator. The guide downstream of the anvil serves to temporarily hold the upstream end portion of the tag cut from the tagging tape, while a downstream end portion of the tag projects from the guide for application by a roller to an article to be tagged. It will be appreciated that, because there is no release liner on the tape, the adhesive side of the tape is always exposed. Thus the non-adhesive side of the tape contacts the concave wall of the guide so that the tagging tape slides freely forward. The sensor element lies on the adhesive side of the tape.

The way in which the tagging tape is cut is important to the successful operation of the applicator. Because the non-adhesive side of the tape contacts the anvil, the cutting takes place on the adhesive side of the tape. Since the applicator may be required to make many thousands of cuts, it is important that adhesive not accrete on the cutting surface of the anvil in a way that impedes the cutting process. Also the cutter must be able to cut through the sensor element without displacing it relative to the tape to which it is adhered, while at the same time always making a clean cut.

In the case of a sensor element that is ductile rather than brittle (as is the case for SSDW) die-cutting may lead to excessive wear on the cutter. On the other hand with shear-cutting the adhesive typically accretes between the two cutting surfaces, and may eventually force them far enough apart so as to prevent them cutting cleanly, or even at all. Consequently, the appropriate selection of the cutter should be made.

In a preferred embodiment the cutter is a crush-cutter made of an appropriately hard material such as tool-steel having a cutting edge and which cuts by crushing the tape between the cutting edge and the anvil. The cutting edge is formed from two intersecting surfaces that make an angle, which is suitably between 30 and 150°, preferably 60 to 120° and more preferably 80 to 100°. A small angle makes a sharper cutting edge, but will wear faster; a large angle wears slowly, but is duller and may accrete adhesive close to the cutting edge. The cutter is driven to impact the tape by a driving mechanism such as a spring. The direction of impact may be at any angle from 30 to 150° to the anvil surface, though best results are obtained at an angle of about 45°. After cutting it is desirable that the cutter leave the anvil surface so that the cut portion of the tagging tape is completely free to be removed from the applicator and applied to the article to be tagged.

In one embodiment, the forward movement of the pressure sensitive tape and the sensor element substrate and of the thus formed tagging tape is effected by a handle which, when squeezed from a starting position, turns the driving rollers via a set of spur gears. The same movement also “loads” the impact cutter by compressing its driving spring. At the end of the movement of the handle, the cutter is released, and the handle is restored to its starting position, ready to advance further sections of the tape and substrate.

A preferred sensor element substrate comprises a continuous length of deactivatable magnetic marker comprising: a detectable member and a deactivating member; the deactivating member comprises a wire having a body consisting of a plurality of first and second alternating body segments, each of the first segments being of magnetizable material having a magnetic resonance of at least 0.2 Tesla, and each of the second segments being of a material having a magnetic saturation of not more than 0.05 Tesla; the detectable member is of a soft magnetic material adapted to provide a desired magnetic signal.

### BRIEF DESCRIPTION OF THE DRAWINGS

FIG. 1 is a schematic side view of an applicator assembly of the invention;

FIG. 2 is a perspective view of the cartridge of the assembly of FIG. 1;

FIG. 3 is a schematic cross-section view of the cartridge of FIG. 2;

FIG. 4 is a schematic view of the guiding and lamination zone of the cartridge of FIG. 2;

FIG. 5 is a schematic detailed view of the feeding and cutting components of the applicator of the assembly of FIG. 1;

FIG. 6 is a schematic front view of the feeding rolls of the assembly of FIG. 1;

FIG. 7 is a perspective view of the exit of the channel guide block of the assembly of FIG. 1;

FIG. 8 is a perspective view of the applicator assembly of the invention in another embodiment;

FIG. 9 is a perspective view of the cartridge of the assembly of FIG. 8; and

FIG. 10 is a schematic detailed view of the feeding and cutting components of the applicator assembly of FIG. 8.

### DESCRIPTION OF PREFERRED EMBODIMENT WITH REFERENCE TO DRAWINGS

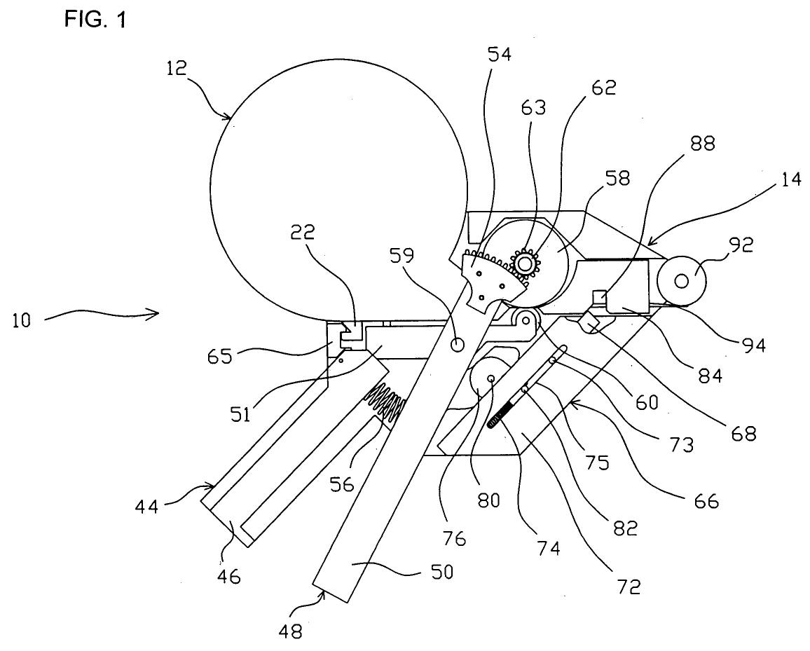

With further reference to FIG. 1, an applicator assembly 10 includes a replaceable spool cartridge 12 and an applicator 14.

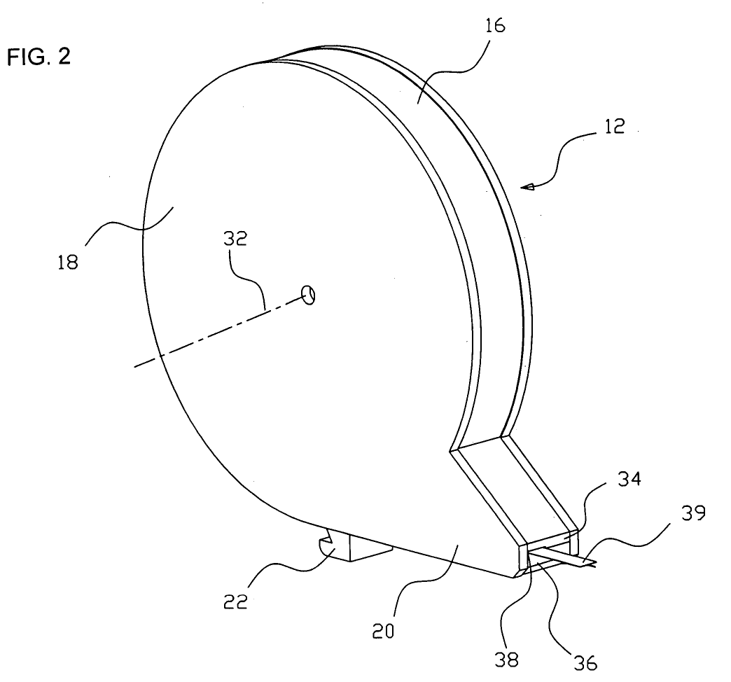

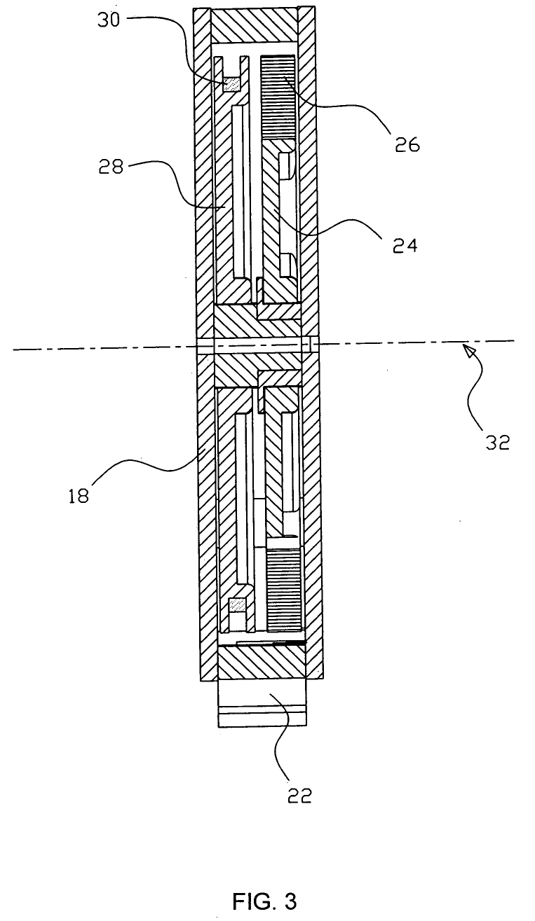

With particular reference to FIGS. 1, 2 and 3, spool cartridge 12 has a housing 16 with a cover 18, a nose 20 and a latch strike 22.

A tape spool 24 and a sensor spool 28 are mounted in housing 16 for free rotation about axis of rotation 32.

Tape spool 24 supports a roll of a continuous pressure-sensitive tape 26, which tape 26 has an adhesive side 25 with a pressure sensitive adhesive thereon and a non-adhesive side 27. Tape 26 has no release liner.

Sensor spool 28 supports a roll of a continuous sensor element substrate 30, such as SSDW.

Nose 20 has an upper laminating wall 34 and a lower laminating wall 36, the walls 34 and 36 being spaced apart by a narrow gap 38. The gap 38 defined by the spacing of walls 34 and 36 is sufficient to press the adhesive side 25 of tape 26 into adhering engagement with substrate 30 and to permit advancement there through of the resulting composite tagging tape 39.

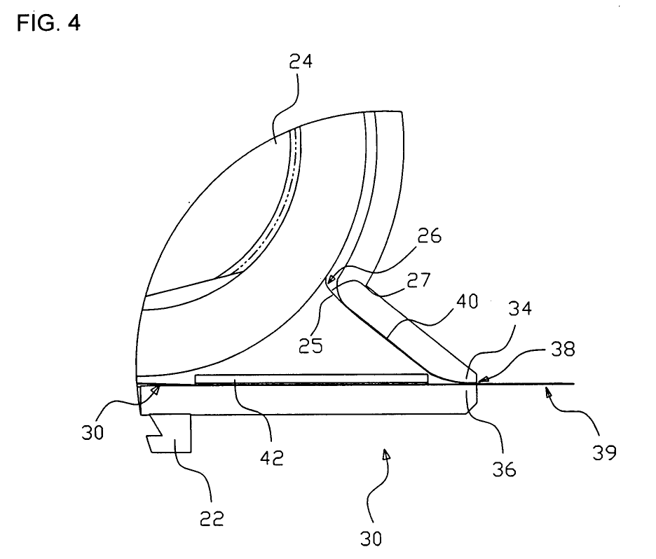

As more particularly illustrated in FIG. 4, nose 20 has a guide surface 40 which guides tape 26 along a first path to narrow gap 38; and a guide 42 which guides substrate 30 along a second path to meet tape 26 in narrow gap 38.

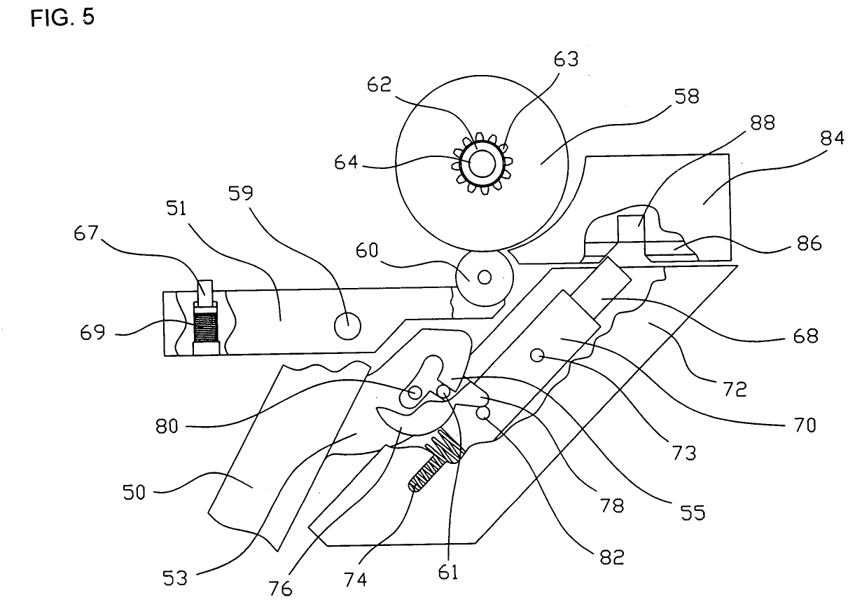

With further reference to FIGS. 1, 5, 6 and 7 applicator 14 includes a frame 44 supporting a drive assembly 45 which includes a fixed handle 46 and a gear drive member 48.

Gear drive member 48 includes a pivotable trigger handle 50 and a drive gear 54. Spring 56 provides spring loading between the fixed handle 46 and the pivotable trigger handle 50.

Trigger handle 50 is pivotably mounted on a lever arm 51 by pivot 59. Trigger handle 50 has a pressing arm 53 having a finger 55.

Lever arm 51 is spring loaded by a compression spring 69, which engages a pin 67 which engages the underside of spool cartridge 12.

Mounted on frame 44 in cooperating relationship with drive assembly 45 is a driven assembly 57 having a friction drive roll 58 and an idler pressure roll 60. Idler pressure roll 60 may suitably have a low adhesion surface, for example, a surface of a tetrafluoroethylene polymer such as that available under the trademark Teflon. The driven roll 58 has a pinion gear 62 with teeth 63 and a clutch bearing 64.

The spool cartridge 12 effectively presses lever arm 51 about pivot 59, so that idler pressure roll 60 is pushed against friction roll 58 to draw and advance tagging tape 39 therebetween from spool cartridge 12, as friction roll 58 is driven by drive assembly 45. When spool cartridge 12 is removed, lever arm 51 pivots about pivot 59 so that idler roll 60 is displaced from friction roll 58.

Latch 65 is supported on frame 44 for releasable engagement with latch strike 22 of spool cartridge 12 whereby spool cartridge 12 is removably supported on frame 44.

A cutter assembly 66 is supported on frame 44. Cutter assembly 66 includes a blade 68, a blade holder 70, a blade cartridge housing 72, a guide pin 73, a spring 74, a guide slot 75 and a catch pin 82.

A cam 76 having a detent 78 and a cam pin 61 is pivotably mounted at pivot 80 on frame 44 with detent 78 releasably engaging catch pin 82 during a non-cutting configuration of cutter assembly 66, and guide pin 73 and catch pin 82 in guide slot 75.

A channel guide block 84 on frame 44 has a guide channel 86 passing therethrough and an anvil 88. Guide channel 86 may be of circular cross-section or preferably of oval or elliptical cross-section having a diameter or long axis of the oval or ellipse smaller than the width of the tape 39. Guide channel 86 defines an arcuate wall 90 against which the non-adhesive side 27 of tape 39 (from tape 26) may slide.

An applicator roll 92 is rotatably mounted on frame 44 downstream of guide block 84 for application to an article of a tag 94 comprising a tape 96 having a sensor 98 adhered thereto by pressure sensitive adhesive 100, which tag is severed from tagging tape 39 by the blade 68 of cutter assembly 66 as will be described hereinafter.

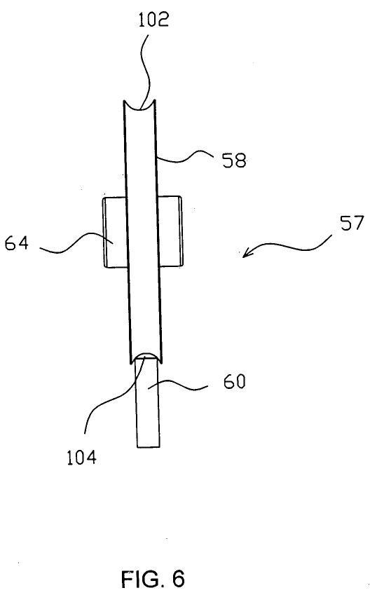

With further reference to FIG. 6, there is shown a particular embodiment of the driven assembly 57 in which the driven roll 58 has a concave surface 102 which defines a nip zone 104 with the idler pressure roll 60 and which facilitates the longitudinal flexing or bending of tagging tape 39 prior to its entry into the guide channel 86 of channel guide block 84.

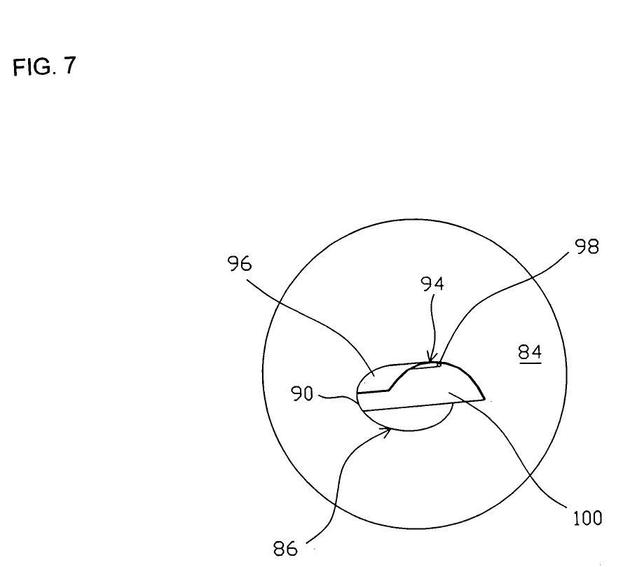

With particular reference to FIG. 7, there is illustrated schematically the emergence of the tag 94 from guide channel 86 of channel guide block 84 ready for application by applicator roll 92 (not shown in FIG. 7).

In especially preferred embodiments, the sensor substrate 30 comprises a continuous length of deactivatable magnetic marker of the type described in EP 1 257 985, an example of which is available commercially under the trademark SSDW of MXT Inc.

In use, and after start-up, handle 50 is squeezed against spring 56 towards fixed handle 46, thus pivoting handle 50 about pivot 59 so that drive gear 54 rotates driven roll 58 by means of pinion gear 62 to draw tagging tape 39 from cartridge 12, which drawing advances further lengths of tape 26 and sensor element substrate 30 from their respective spools 24 and 28.

As the tape 26 and sensor element substrate 30 are advanced from their respective spools 24 and 28, tape 26 is guided at its non-adhesive side 27 by guide surface 40 along the first path towards nose 20, and the sensor element substrate 30 is guided along the second path by guide 42 towards nose 20.

The guide 42 offsets the travel of the sensor element substrate 30 and aligns it with the centerline of tape 26 at narrow gap 38. As the tape 26 and sensor element substrate 30 are drawn through narrow gap 38, they are pressed together by upper and lower laminating walls 34 and 36 so that sensor element substrate 30 and the adhesive side 25 of tape 26 are pressed into engagement, whereby the resulting composite tagging tape 39 is drawn from narrow gap 38 and in which the sensor element substrate 30 is adhered to the adhesive side 25 of tape 26.

As the tagging tape 39 is drawn through nip zone 104 of the driven assembly 57, the concave surface 102 of driven roll 58 engages the non-adhesive side 27 and flexes or bends the tagging tape 39 longitudinally facilitating its entry into the guide channel 86 of guide block 84 where the non-adhesive side 27 of tagging tape 39 slides along arcuate wall 90 and generally conforms to the shape of the arcuate wall 90. This longitudinal flexing or bending of the tagging tape 39 serves to stiffen it so as to facilitate the pushing forward of the tagging tape 39 permitting the passage through guide block 84 of a free protruding forward end of tagging tape. In other words, the forward portion of the tape 39 is free and unobstructed by a drawing or pulling mechanism. In the channel guide block 84, the tagging tape 39 is advanced over anvil 88.

The activation of the drive assembly 45 also activates cutter assembly 66. When trigger handle 50 is squeezed towards fixed handle 46 about pivot 59, finger 55 engages cam pin 61 and rotates cam 76 about pivot 80 with detent 78 engaging catch pin 82. As rotation of cam 76 continues, catch pin 82 is released from engagement with detent 78 and spring 74 forcefully drives blade holder 70 with blade 68 to impact anvil 88; the movement of blade holder 70 is guided by guide pin 73 and catch pin 82, in guide slot 75. In each cycle of activation of drive assembly 45, the detent 78 of cam 76 engages the catch pin 82 moving the blade holder 70 with blade 68 away from anvil 88 with compression of spring 74, with the continuing rotation of cam 76, detent 78 is disengaged from catch pin 82 whereon the compressed spring 74 expands driving blade holder 70 with blade 68 towards anvil 88 so that blade 68 impacts anvil 88 and a cutting edge of blade 68 severs tagging tape 39 where it is sandwiched between anvil 86 and the cutting edge, thereby freeing a short length of the free or protruding end of tagging tape 39 as tag 94 for application by applicator roll 92 to an article which is to be tagged.

The thus formed tag 94 is partly retained at its upstream end portion within guide channel 86, and a free downstream end portion of tag 94 protrudes from guide block 84 with the non-adhesive side 27 adjacent applicator roll 92, so that tag 94 is ready to be applied to an article to be tagged by applicator roll 92.

The foregoing operation represents a complete cycle and is repeated intermittently or continually as desired with each additional or successive cycle producing an additional tag 94 for application to an article.

As use of the applicator assembly 10 proceeds, the cartridge 12 is gradually exhausted of tape 26 and sensor element substrate 30, thereon the spool cartridge 12 is released from the applicator assembly 10 at latch 65. A fresh spool cartridge 12 can then be loaded on the applicator 14 or the used spool cartridge may be filled with fresh spools 24 and 28 by first removing cover 18 of housing 16, replacing the spools and hand-feeding the outer free ends of the fresh tape 26 and fresh sensor element substrate 30 along the first and second paths through narrow gap 38 to the nip zone 104, and restoring cover 18.

The applicator assembly 10 thus provides a simple, hand-operated means, of forming and delivering a remotely detectable tag at a site of application of the tag to an article, and additionally of directly applying the tag, immediate on its formation, to an article to be tagged. In the especially preferred embodiment as illustrated, the applicator assembly 10 is a portable, hand-held, hand-operated device, whereby the tag 94 can be formed directly at the site when the tag is to be applied to an article.

In the embodiment illustrated, a single cam 76 is shown for convenience, in particular embodiments there is a pair of such cams 76 on opposed sides of applicator 14 mounted pivotally on pin 80, with cam pin 61 mounted between the two cams 76. The two cams 76 operate as one, as finger 55 presses on cam pin 61.

The applicator assembly 10 is thus composed of two sub-assemblies, the spool cartridge 12 and the applicator 14. The spool cartridge 12 provides the storage and payoff of the two components of the tag. The spool cartridge 12 is releasably latched to the applicator 14 and the formation and feed of tagging tape 39 and cutting or severing of successive tags 94 from the tagging tape is effected by a handle which, when squeezed, turns the drive assembly by means of the gears, and the same movement loads the cutter assembly by compressing its driving spring. At the end of the movement of the handle, the cutter is released.

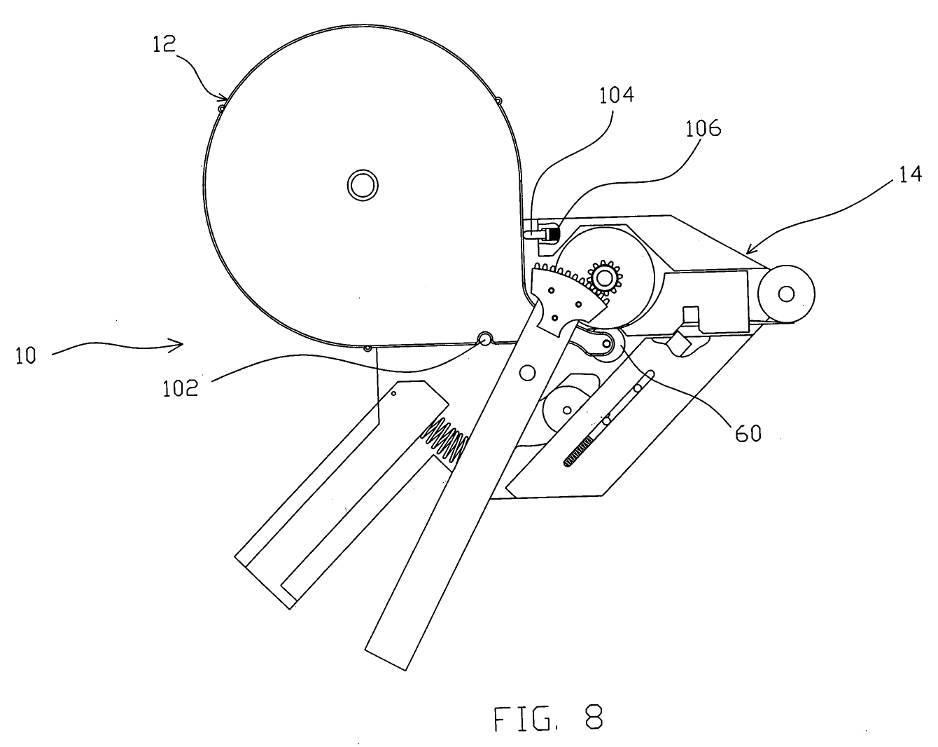

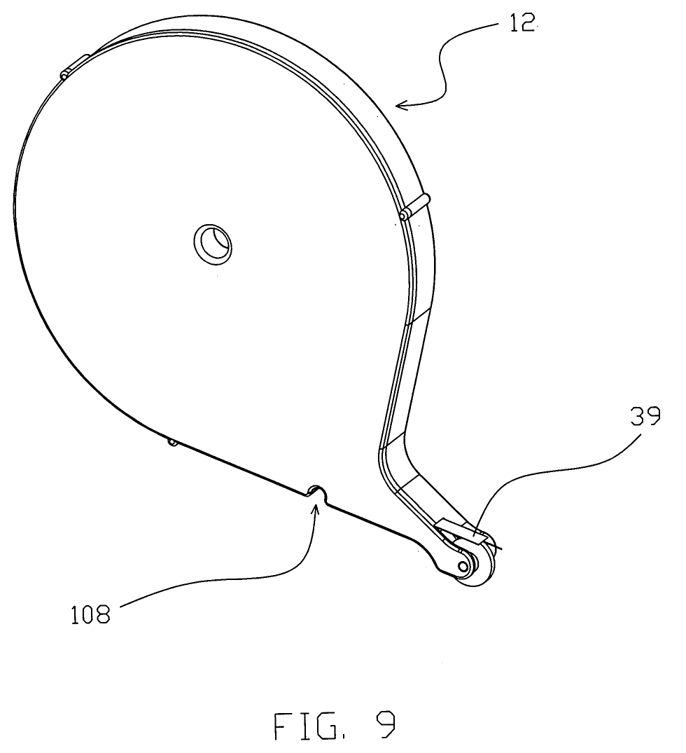

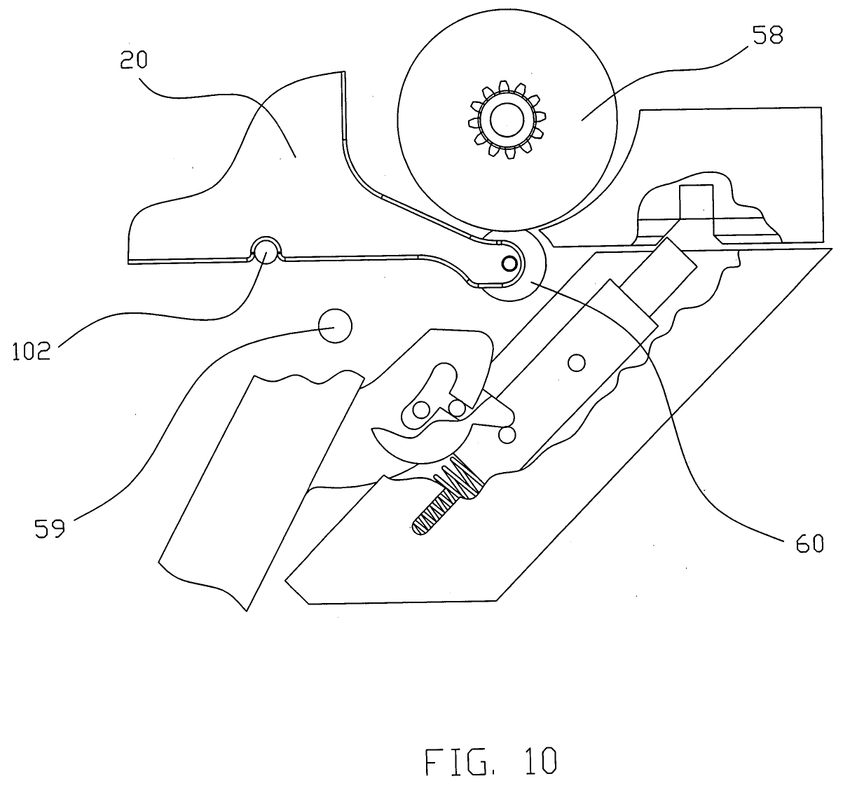

With further reference to FIGS. 8, 9 and 10, there is illustrated an applicator assembly 10 in a second embodiment. The applicator assembly 10 and parts thereof, in FIGS. 8, 9 and 10, differ from those in FIGS. 1 to 7, primarily in that idler pressure roll 60 is mounted on cartridge 12, and is part of cartridge 12 rather than being mounted on, and part of applicator 14. The other differences are consequent on the relocation of idler pressure roll 60 to cartridge 12.

In FIGS. 8, 9 and 10, the same integers are employed to identify the same parts of the assembly 10 as in FIGS. 1 to 7. In this embodiment of FIGS. 8, 9 and 10, when the cartridge 12 is placed inside the applicator 14, the roll 60 performs its function of advancing the tagging tape 39 by pressing it against the driving roll 58.

The embodiment of FIGS. 8 to 10 has the advantage that it simplifies the design and makes loading of the cartridge 12 in the applicator 14 easier.

In the embodiment of FIGS. 8 to 10, cartridge 12 further includes a groove 108, for a pivot pin 102 about which housing 16 of cartridge 12 is pivotably moveable.

Pin 102 is mounted on applicator 14, more especially on frame 44. Applicator 14 further includes a plunger 104 loaded with a plunger spring 106. In the assembly 10, spring 106 urges plunger 104 against housing 16, thereby pivoting the housing 16 about pivot pin 102 and urging roller 60 towards drive roll 58, thereby providing the pressure to advance tape 39.

Groove 108 serves the function of locating and locking the cartridge 12 in place in assembly 10, as well as providing a surface for housing 16 to pivot about pin 102. Thus, in operation of the assembly of FIGS. 8 to 10, the spring loaded plunger 104 engages the cartridge 12 and pivotally moves it about pivot pin 102, and this pivotal movement urges roller 60, mounted on cartridge 12 towards roller 58 on applicator 14, and advances the tagging tape 39 by pressing it against the driving roll 58.

1. A method of delivering a remotely detectable tag for tagging an article comprising the steps of:
(a) advancing a continuous pressure sensitive tape from a first source such that said tape travels along a first path, said tape having an adhesive side and an opposed non-adhesive side (
(b) advancing a continuous sensor element substrate of a remotely detectable material from a second source adjacent said first source, and into adhering engagement with said adhesive side of said tape so as to form a composite tagging tape downstream of said first and second sources
(c) advancing said tagging tape along said first path so as to provide a free protruding forward end portion of tagging tape, and
(d) severing said forward end portion as a tag of said pressure sensitive tape bearing a sensor element of said substrate on the adhesive side of the tape.

2. A method according to claim 1, wherein steps (a) and (b) are carried out simultaneously.

3. A method according to claim 1, wherein said tagging tape is stiffened and pushed forwardly to advance it in step (c).

4. A method according to claim 3, which comprises feeding said tagging tape through a guide having an arcuate channel such that said tagging tape is flexed longitudinally with said non-adhesive side of said tagging tape conforming to and sliding along an arcuate wall of said channel whereby the tape is stiffened.

5. A method according to claim 1, wherein step (b) comprises advancing said continuous sensor element substrate from said second source along a second path and deflecting the advancing continuous sensor element substrate from said second path to engage said adhesive side of said tape in said first path.

6. A method according to claim 5, wherein said first source comprises a first spool of said tape and said second source comprises a second spool of said sensor element substrate, said first and second spools being on a common axis of rotation.

7. A method according to claim 6, wherein said first and second spools are in opposed, spaced apart relationship.

8. A method according to claim 6, wherein steps (a) and (b) are carried out by drawing said tape and said sensor element substrate from said first and second spools between first and second rolls and pressing advancing sensor element substrate into engagement with the adhesive side of advancing tape upstream of said first and second rollers.

9. A method according to claim 4, wherein in step (d) the stiffened tagging tape is pushed forwardly over an anvil, and a cutting edge of a cutting member impacts the tape (on said anvil to sever said free protruding forward end portion from said tagging tape; said cutting edge being formed between a pair of intersecting surfaces that make an angle of 30 to 150°, and said cutting edge impacts said tagging tape on said anvil at an impact direction of 30 to 150° to a surface of the anvil opposed to the tagging tape.

10. A method according to claim 4, wherein step (b) comprises:
advancing said continuous sensor element substrate from said second source along a second path and deflecting the advancing continuous sensor element substrate from said second path to engage said adhesive side of said tape in said first path;
wherein said first source comprises a first spool of said tape and said second source comprises a second spool of said sensor element substrate, said first and second spools (being on a common axis of rotation;
said first and second spools being in opposed, spaced apart relationship; and wherein steps (a) and (b) are carried out by drawing said tape and said sensor element substrate from said first and second spools between first and second rolls, and pressing advancing sensor element substrate into engagement with the adhesive side of advancing tape; and wherein in step (d) the stiffened tagging tape is pushed forwardly over an anvil, and a cutting edge of a cutting member impacts the tape on said anvil to sever said free, protruding forward end portion from said tagging tape; said cutting edge being formed between a pair of intersecting surfaces that make an angle of 30 to 150°, and said cutting edge impacts said tagging tape on said anvil at an impact direction of 30 to 150° to a surface of the anvil opposed to the tagging tape.

11. A method according to claim 1, wherein said sensor element substrate comprises a continuous length of deactivatable magnetic marker comprising: a detectable member and a deactivating member, said deactivating member comprising a wire having a body consisting of a plurality of first and second alternating body segments, each of said first segments being of magnetizable material having a magnetic resonance of at least 0.2 Tesla, and each of said second segments being of a material having a magnetic saturation of not more than 0.05 Tesla; said detectable member being of a soft magnetic material adapted to provide a desired magnetic signal.

12. A method according to claim 1, wherein (a), (b), (c) and (d) form a tag forming and delivering cycle, and the cycle is repeated continually to deliver a plurality of said tags.

13. A method of tagging an article with a remotely detectable tag comprising the steps of:
(a) advancing a continuous pressure sensitive tape from a first source such that said tape travels along a first path, said tape having an adhesive side and an opposed non-adhesive side,
(b) advancing a continuous sensor element substrate of a remotely detectable material from a second source adjacent said front source, and into adhering engagement with said adhesive side of said tape so as to form a composite tagging tape downstream of said first and second sources,
(c) advancing said tagging tape along said first path so as to provide a free protruding forward end portion of tagging tape,
(d) severing said forward end portion as a tag of said pressure sensitive tape bearing a sensor element of said substrate on the adhesive side of the tape, and
e) delivering said tag, to an article, and adhering the tag to the article by means of the adhesive side of the tag.

14. A device for forming a remotely detectable tag for an article comprising:
(i) a first source of a continuous pressure sensitive tape having an adhesive side and an opposed non-adhesive side,
(ii) a second source of a continuous sensor element substrate of a remotely detectable material,
(iii) means for drawing said tape and said sensor element substrate and advancing them along first and second paths from said first and second sources respectively, and into an engagement in which the advancing sensor element substrate is adheringly engaged by the adhesive side of the advancing tape to form an advancing tagging tape,
(iv) means for stiffening and guiding the advancing tagging tape so as to provide a free, protruding forward end portion of tagging tape, and
(v) severing means to sever the forward end portion as a tag of said pressure sensitive tape bearing a sensor element of said substrate on the adhesive side of the tape.

15. A device according to claim 14, wherein said first and second sources are housed in a housing having an exit port for the tagging tape, said exit port having closely spaced apart, opposed laminating walls for pressing said tape and said substrate into adhering engagement.

16. A device according to claim 14, comprising a frame supporting:
first and second opposed rollers for advancing said tagging tape, and
a guide for receiving the advancing tagging tape from said rollers; said guide having an arcuate channel for stiffening the advancing tagging tape.

17. A device according to claim 15, comprising a frame, a pivot pin mounted on said frame for engaging said housing for pivotal movement of said housing relative to said frame,
said frame supporting a first roller and said housing supporting a second roller in opposed relationship with said first roller for advancing the tagging tape,
said frame further supporting a guide for receiving the advancing tape from said rollers, said guide having an arcuate channel for stiffening the advancing tagging tape.

18. A device according to claim 17, further including a spring loaded drive assembly comprising a first handle member fixed to said frame and a second handle member pivotally mounted to said frame for spring loaded pivotal movement on said frame relative to said first handle,
a drive gear mounted on said second handle member in gear driving relationship with a gear driven means on said first roller, whereby pivotal movement of said second handle member against said spring loading towards said first handle member drivingly rotates said first roller against said second roller for the advancing of the tagging tape; and
cam means rotatably mounted on said frame in cooperable relationship with said second handle member; said cam means being adapted to releasably engage a catch member on a spring loaded blade member, whereby release of the catch member on progressive rotation of said cam means releases the spring loaded blade member for impact drive to engage and sever the tagging tape.

19. A device according to claim 17, wherein said housing and said frame have cooperating latch means defining a releasable latch whereby said housing is releasably mounted on said frame;
said device being portable and hand operated whereby the tag can be both formed and applied at the side of the article.

20. A device according to claim 17, wherein said housing has a groove defined therein for receiving said pivot pin.

21. A replaceable spool cartridge for an applicator for forming a remotely detectable tag for an article comprising:
a housing having a spool chamber and an exit port,
a first spool of a continuous pressure sensitive tape and a second spool of a continuous sensor element substrate rotatably mounted in said housing,
said pressure sensitive tape having an adhesive side and a non-adhesive side, a tape guide for guiding tape from said first spool to said exit port, such that said tape guide engages said non-adhesive side, and
a substrate guide for guiding substrate from said second spool to said exit port,
said exit port having a narrow gap defined between closely spaced apart, opposed laminating walls such that said walls press said substrate and tape into adhering contact at said adhesive side of said tape, as said tape and substrate are drawn through said narrow gap.

22. A cartridge according to claim 21, further including a pressure roll mounted for rotation on said housing, adjacent said exit port; and
a groove defined in said housing for receiving a pivot pin of the applicator for pivotal movement of said housing about said pivot pin.

23. A cartridge according to claim 21, further including latch means for releasably engaging a cooperating latch means of the applicator.

24. An applicator for forming a remotely detectable tag for an article comprising:
(I) drive means for driving a pressure sensitive tape and a sensor element substrate from first and second sources to form a composite tagging tape in which sensor element substrate is adhered to an adhesive side of the pressure sensitive tape, and for advancing the tagging tape,
(II) guide means for stiffening and guiding the advancing tagging tape so as to provide a free protruding forward end portion of tagging tape, and
(III) severing means to sever the forward end portion as a tag.

25. An applicator according to claim 24, further including a pivot pin for engagement with a cartridge for housing said first and second sources such that said cartridge is pivotable about said pivot pin, and
a spring-loaded plunger for engaging the cartridge for pivotal movement about said pivot pin, said drive means including a first roller, and said pivotal movement urging a second roller, mounted on said cartridge, towards said first roller for the advancing of the tagging tape.
